(19) United States
(12) Patent Application Publication
(10) Pub. No.: US 2010/0211198 A1
(43) Pub. Date: Aug. 19, 2010

(54) Tools and Methods for Collecting and Analyzing Sports Statistics

(76) Inventor: Michael J. Ressler, Pittsburgh, PA (US)

Correspondence Address: MATTHEW E. BURR, 620 CONGRESS AVENUE, STE 320, AUSTIN, TX, 78701, US

(21) Appl. No.: 12/705,579

(22) Filed: Feb. 13, 2010

Related U.S. Application Data
(60) Provisional application No. 61/152,299, filed on Feb. 13, 2009.

(51) Int. Cl. G06F 19/00; A63F 9/24

(52) U.S. Cl. 700/91; 463/40; 463/43

(57) ABSTRACT

An application executed on a computer running Windows or Vista, for example, allows the coach to take whatever sports statistics his heart desires and then provides the coach with the tools to analyze those statistics. Data entry of statistics is easy and specific embodiments contemplate voice recognition data entry and analysis and tagged video associated with one or more statistical event. The application runs as a desktop application but also synchs with an online database on a server for online access and synchs a particular statistic to a video clip of the event that created the statistic.

### CROSS-REFERENCE TO RELATED APPLICATIONS

This disclosure is related to, claims priority from, and the benefit of U.S. Provisional Patent Application of the same title and by the same inventor, Ser. No. 61/152,299, filed Feb. 13, 2009, the disclosure of which is incorporated herein by reference.

### TECHNICAL FIELD

This invention relates generally to methods and machine-readable media for statistics and more particularly to for collecting and analyzing sports statistics.

### BACKGROUND

Current sports statistics packages come pre-packaged with the list of N types of statistics you can take. N is usually in the range of 30 to 75. Prior statistics programs follow a similar path for their available views on those statistics. Such prior programs are not truly user configurable and they often constrain the coach in some way.

The present disclosure describes specific embodiments of a software application for sports statistics that can be executed or run on a personal computer (PC), laptop, portable electronic device or any machine that executes machine readable instructions, preferably one that runs a Windows or Vista operating system, as well as open source such as a Linux operating system, or MacOS for Macintosh computers. For convenient reference, a specific embodiment of the application is referred to herein as “StatEasy.” StatEasy is focused on allowing the coach to take whatever statistics his or her heart desires and then providing the coach with tools to analyze those statistics.

Ease of data entry is at the heart of StatEasy. Prior art products gave some thought to data entry, but most fall far short of what would be required for a fast paced, stat intensive sport such as hockey or volleyball. Many prior art products require actually looking at the device you're recording statistics with. The goal of StatEasy is to allow the user to keep their eyes on the game at all times to allow them to not miss a single statistic. For example, keyboard data entry allows heads-up touch typing at the keyboard to enter data while watching a game.

Another form of data entry is voice recognition. Voice Recognition has long been a goal of many coaches when thinking about statistics. Unfortunately, not many products offer such a solution and of those that do many do not come close to the accuracy needed to keep up with the game.

Still another form of data entry is video. Almost every coach already keeps some form of video on their games. Whether they use this as a tool to teach their players or as a tool to review by themselves, coaches use video early and often. StatEasy attempts to make watching game footage a more valuable tool in the analysis of a team's performance.

### SUMMARY

The StatEasy application is a Sports Statistics Framework focused on ease of data entry and flexibility. It is a sport agnostic framework that provides the user with enough flexibility to tackle the most stat intensive sports while also being easy to set up. It has two optional components that provide significant value add to the consumer: Voice Recognition & Video Tagging. The Voice Recognition component makes use of the best fixed-vocabulary, trainer dependent voice recognition engines. The Video Tagging component adds statistical information to any video feed.

The StatEasy application takes advantage of its web application roots and supports synchronization to RessQ.com servers. This synchronization provides benefits for the players, coaches, schools, organizations, teams and fans. Statistics taken using StatEasy and then synchronized to an internet server, such as RessQ.com servers, are available to any citizen of the Internet. This means that anyone will be able to visit a web site such as RessQ.com and browse player & team statistics. Any customer using the Video Tagging component will also upload their video feeds to RessQ.com servers. With the video data, anyone interested in perusing the statistics can also view the play in which that stat occurred. This video data tagged with statistics will be a huge boon for any player hoping to create a highlight reel for potential college recruiters. Alternative embodiments provide password protected or secure access to server data.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of a computer display screen shot for a specific exemplary embodiment of a configuration user interface of the present disclosure.

FIG. 2 is a diagrammatic illustration of a computer display screen shot for a specific exemplary embodiment of a statistics user interface of the present disclosure.

FIG. 3 is a diagrammatic illustration of a computer display screen shot for a specific exemplary embodiment of a configuration sub-tab user interface of the present disclosure.

FIG. 4 is a diagrammatic illustration of a computer display screen shot for a specific exemplary embodiment of a video linking user interface of the present disclosure.

FIG. 5 is a diagrammatic illustration of a computer display screen shot for a specific exemplary embodiment of a configuration user interface of the present disclosure for setting up a new statistic.

FIG. 6 is a diagrammatic illustration of a computer display screen shot for a specific exemplary embodiment of a configuration user interface of the present disclosure to set up the effect of a stat.

FIG. 7 is a diagrammatic illustration of a computer display screen shot for a specific exemplary embodiment of a report generation user interface of the present disclosure.

FIG. 8 is a diagrammatic illustration of a computer display screen shot for a specific exemplary embodiment of a report generated from the interface of FIG. 7.

FIG. 9 is a diagrammatic illustration of a computer display screen shot for a specific exemplary embodiment of a video segment play interface of the present disclosure.

FIG. 10 is a process flow diagram for synchronizing a stat to a video segment in accordance with the present disclosure.

### DETAILED DESCRIPTION

### StatEasy Client

The StatEasy client is an “application server” run locally on the customer's computer. All statistics processing, video tagging, video synchronizing, and voice recognition happens locally at the StatEasy client, not shipped back to an internet server such as the RessQ.com servers for processing. This allows the end user to record statistics continually even while outside of normal network coverage.

Stats & Language

The language used to define all types of statistics that the end user will take is a very simple interpreted language. It allows the user to configure one stat type as a collection of other data types. Examples allowable data types, without limitation, are:
Numerical Data
Player Data
Time Data
Location Data

Once a stat type is configured in the system, it will immediately be available to be taken during games and configured in views. After a stat type has been taken in a game or configured in a view, it will become immutable. Any desired modifications to the stat will be accomplished by adding a new stat type to the system and reconfiguring the relevant views.

StatEffects & GameState

In addition to defining the types of data required for taking a particular statistic, the StatEasy system also has a concept referred to as a StatEffect. A StatEffect is simply a chunk of interpreted JavaScript code that gets executed when a stat is taken. The JavaScript is handed a large amount of context pertaining to the current GameState and is given an opportunity to update the GameState as it sees fit. The GameState in this context is left intentionally vague as all sports can have a plethora of potential attributes contributing to what can be called the GameState. It should be enough to say that any GameState can be viewed as simply a collection of name and value pairs.

Every statistic taken in the StatEasy system will record its initial GameState and the GameState after its StatEffect has been executed. In this way, a user will be able to query the system through the Views subsystem to ask such questions as, “What pitch has this pitcher thrown when the count was 3-2 and he faced a left handed batter?” or “What play did the other team run most often when inside the red zone?” and so forth. The limits to the possible questions to be asked should only be on the imagination of the individual and not on the system itself.

LiveViews

Given that every stat taken during the game has an opportunity to update the GameState, a user will be very interested in the current state of the game as they collect statistics. To display this ever updating GameState as well as provide the user with other contextual information, StatEasy introduces what will be referred to herein as LiveView. The LiveViews of StatEasy are JavaScript classes that get executed in the Web Browser used by the end user. They are handed an area of the web page (“div”) and told to draw their information inside of that area. The user can select which or how many LiveViews they would like to view.

By way of example, these LiveViews can draw things such as “heat maps” of where pitchers have thrown, current rotation for volleyball, what yard is the ball on for football, and so forth. To accomplish this, they are given as much context as possible by the StatEasy application.

There is not much use to taking statistics if they are difficult to retrieve, display and analyze. To this end, the View subsystem of StatEasy is focused on providing the user with any data the user is likely to want to retrieve from their statistics.

In order to accomplish this, StatEasy uses a simple interpreted language that performs calculations on the statistics in preparation for display to the user. The language allows for arithmetic operations such as “+”, “−”, “*” and “/” as well as standard database operations such as “count”, “min”, “max”, “sum” and “avg”. The language combines these standard operations with StatEasy concepts such as the stat type to allow for fast retrieval and operation on the data. For example, the language allows the data to be operated on so that, in the view subsystem of StatEasy, any generated report can link a stat to its underlying video—that is, to a video of the event that generated the stat—so that by clicking on the numerical stat the view system opens a video window and runs the linked video of the event.

A specific exemplary embodiment of the syntax follows the pattern: “database operation” (“stat shortcut” [, “player index selector” [&“player modification”][, “data index selector” [&“data modification”]]]); where: the expressions in brackets are optional, “player index selector” and “data index selector” can be integers or the character ‘*’ to denote any position, and “player modification” and “data modification” are used to further refine the criteria of the calculation. For example, to count up all stats with shortcut “k” by a player, the user would use the expression count(k). To average all stats with shortcut “p” in which the player was the first data entered and the numerical data was the second data point entered, the user would use the expression avg(p, 0, 1). To find the largest data entered for a statistic with shortcut “r” the user could use the expression max(r). To count the number of stats with shortcut “ba” in which the player appears anywhere in the data, the user could use the expression count(ba, *).

The views of StatEasy will be standard graphs and charts found in most spreadsheet applications. Special care has been taken to allow for future development in this area as customer needs arise.

Stat Packages

To facilitate quick setup of the StatEasy application, the concept of Stat Packages has been introduced. It is the expectation that although coaches will want to take special stats for their particular situation, most statistics taken for a given sport will be common across all coaches. This common set of Stat Types, Live Views and Views is known as the Stat Package. Any web developer may be able to enhance their installation of StatEasy and share such enhancements with other coaches using the Stat Package subsystem of StatEasy.

Voice Recognition

Due to the loud nature of sports (and their respective fans), collecting sports statistics through live, real-time Voice Recognition has always been a challenge. Through the use of trainable speaker dependent, fixed-set vocabulary recognizers and noise canceling microphones, StatEasy will be able to reliably recognize the statistics spoken by its users. The recognition of statistics will be communicated back to the StatEasy client for storage and synchronization to the servers. Specific embodiments enable taking statistics via keyboard for the voice user either through a display on the StatEasy client or through a “Voice User Interface”.

Video Feed

The Video Feed subsystem of StatEasy will allow a user to film their game and import that video data into the StatEasy application. The importing of the video data will happen after or during the game and can come from any standard video format supported by most handheld video cameras.

Since the statistics are taken in real time and timestamped relative to each other and the start of the game, StatEasy can “tag” the video feeds with the relevant statistics. Such tagged video feeds will be then available to be watched from the StatEasy client application as well as the StatEasy server application hosted by a server such as the RessQ.com servers.

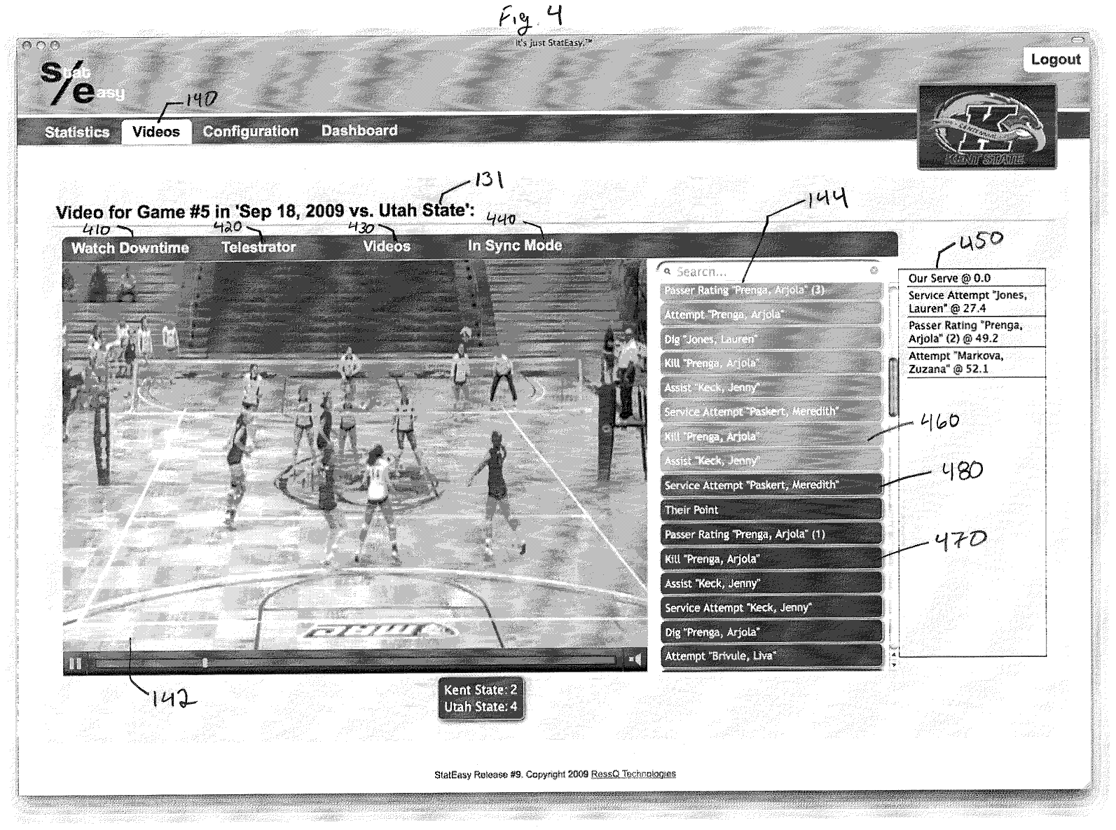

The user interface around the video feeds will allow any end user to see the video roughly synced with as many video feeds as are available (not necessarily at the same time). As the statistics happen in real time during the playback of the video feed, a live scrolling display window shows what statistics are occurring (See FIG. 4, below). This is to allow for post game statistic accuracy as well as game review.

Through any View provided by StatEasy, the user will be able to “drill down” into statistics to get access to the relevant video associated with the statistic.

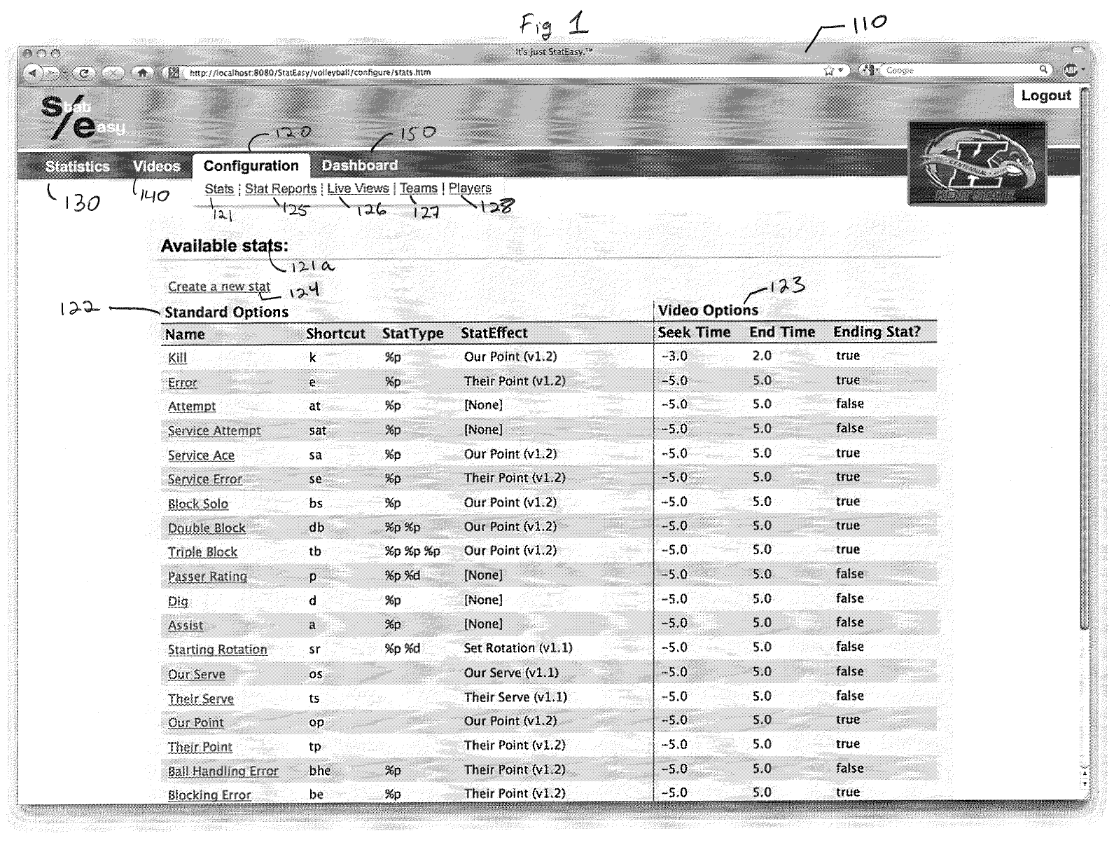

Turning now to the drawings, FIG. 1 is a diagrammatic illustration of a computer display screen shot for a specific exemplary embodiment of a configuration user interface of the present disclosure. Browser window 110 provides without limitation tabs for Statistics 130, Videos 140, Configuration 120, and Dashboard 150.

Configuration tab 120 further provides sub-tab 121 for stats for a user to configure the statistics that may be kept by the application. Available stats 121a lists standard statistical options 122 on the left of the display and video options 123 to the right of the display. A new statistical category or type of statistic may be configured by the user by activation of the Create a new stat feature 124. Configuration tab 120 further provides exemplary sub-tabs stat reports 125; Live views 126, teams 127, and Players 128.

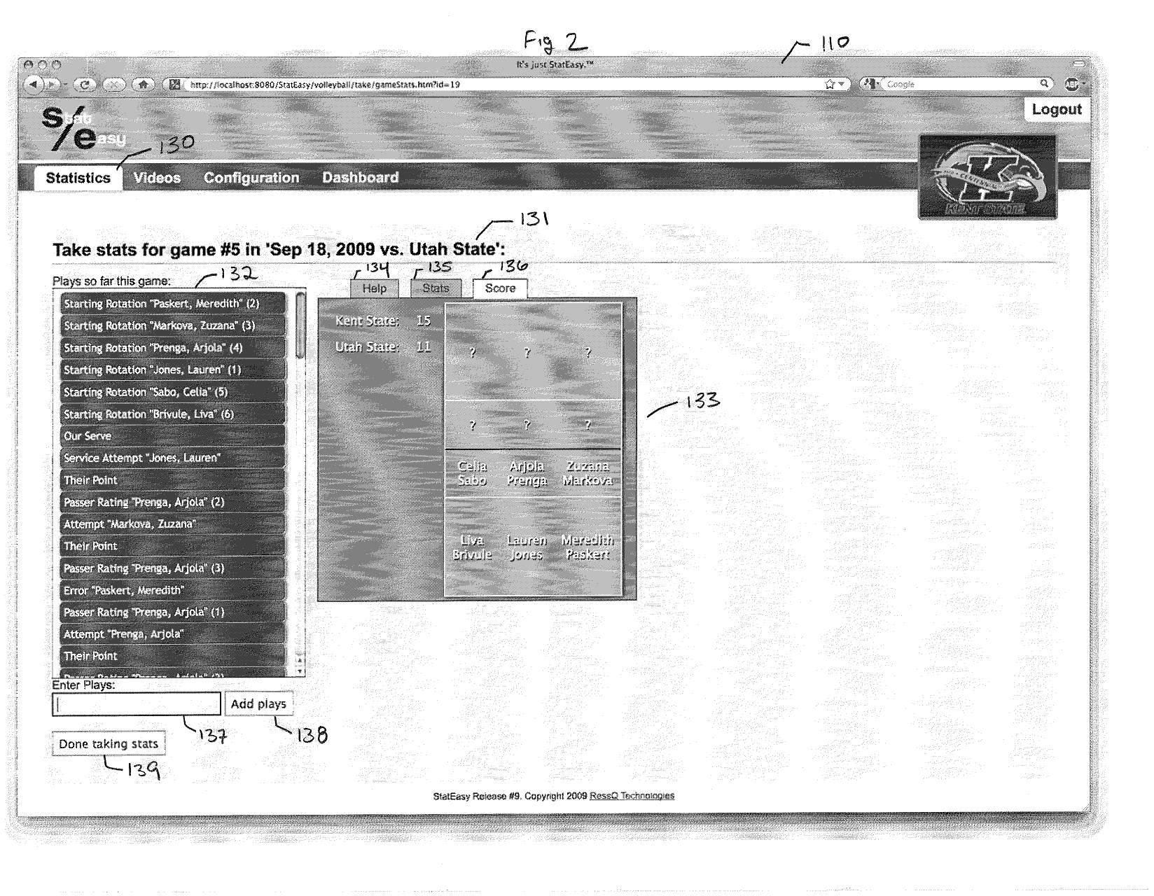

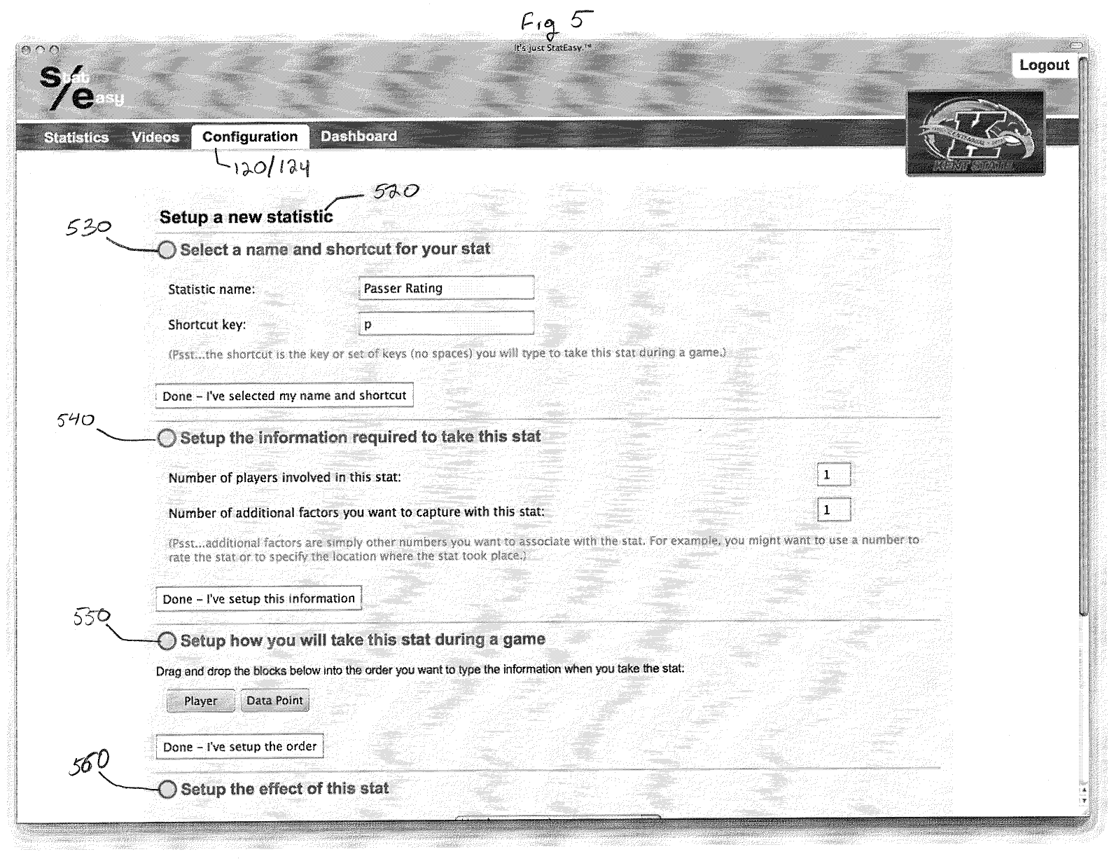

FIG. 2 is a diagrammatic illustration of a computer display screen shot for a specific exemplary embodiment of a statistics user interface of the present disclosure. Browser window 110 provides Statistics tab 130 to take stats for a game 131. Display 132 lists the plays so far in game 131. Display 133 provides tabs for help 134, stats 135, and score 136. Plays may be added to display 132 by entering the play into box 137 in the format specified by the configuration as in FIG. 5 below. Since the configuration screen as in FIG. 5 completely specifies the language that the statistics will be entered in, no additional input 138 (such as pressing enter, or clicking on a button) is necessary. This allows for rapid, accurate, data entry by keyboard. Statistics for game 131 may be finalized upon activation of the “Done taking stats” virtual button 139.

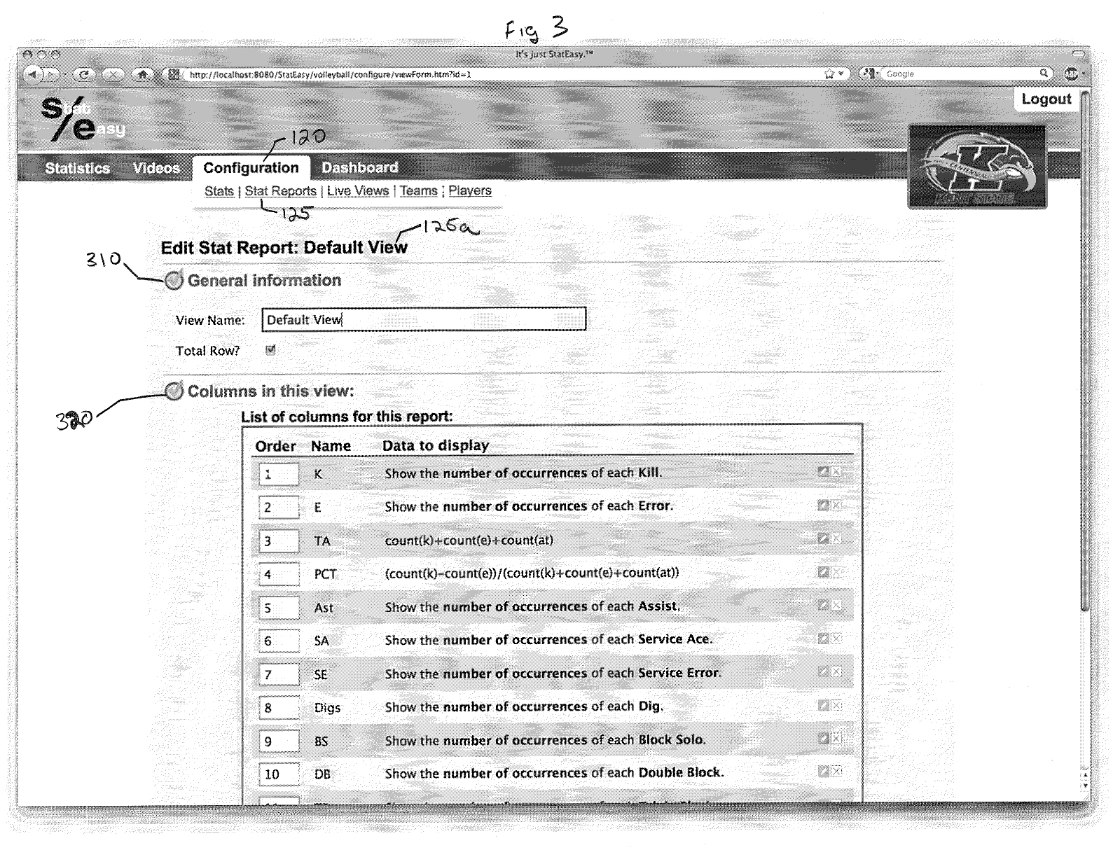

FIG. 3 is a diagrammatic illustration of a computer display screen shot for a specific exemplary embodiment of a configuration sub-tab user interface of the present disclosure. A stat report may be edited by the user under sub-tab “Stat reports” 125 under configuration tab 120 to generate the edit page 125a. Editable information includes without limitation general information 310, and columns 320. Editing column 320 allows the user to specify the calculations to be used. For example, in volleyball, columns 320 may be edited to show the number of kills, digs, services aces, blocks and so forth.

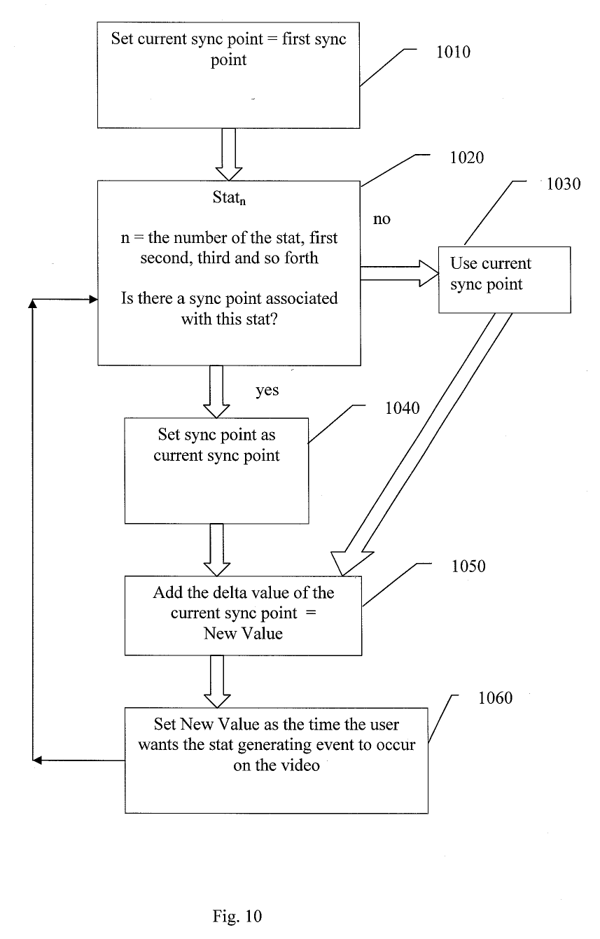

FIG. 4 is a diagrammatic illustration of a computer display screen shot for a specific exemplary embodiment of a video linking user interface of the present disclosure. Activation of video tab 140 opens video window 142. Along the top of window 142 are tabs watch downtime 410, telestrator 420, videos 430, and in sync mode 440. On the immediate right of the video 142 is a list 144 of stats that are applicable to game 131. Some of the stats 460 are a lighter color than the others. The stats 460 that are grayed out have happened in the past. One of the stats 480 is highlighted, which means that the event that generated the stat just happened. Also listed 470 are stats 121 defined in FIG. 1. To the right of the stat list 144 is the list of synchronization or linking points. Synchronization, or linking, links the segment of video that shows the event that generated a stat to the record of that stat so that by activating a hypertext link numerical record of the stat the user may view the event that generated it. A synchronization point is added when a user clicks on a stat. The number on the synchronization point corresponds to the time in the video when it was clicked. The logic flow for the synchronization process is given in detail below in FIG. 10.

FIG. 5 is a diagrammatic illustration of a computer display screen shot for a specific exemplary embodiment of a configuration user interface of the present disclosure for setting up a new statistic. Activation of virtual button 124 in FIG. 1 generates interface 520 for setting up a new statistic. Options are provided to name a Tools and Methods for Collecting and Analyzing Sports Statistics stat and short cut key 530; set up the information required for the stat 540, set up how the stat will be taken during a game 550 and to set up the effect of the stat 560. Configuration of the statistics under this tab creates the “language” with which stats data is input into StatEasy. For example, if the data is input by keyboard then appropriate configuration with interface 520 enables StatEasy to immediately recognize when a complete statistic has been entered and save the statistical information as well as time stamp data to be used later in the video synchronization portion of StatEasy. Another example is that interface 520 allows for such complete vocabulary (language) specification that other user interfaces such as a grammar matching voice recognition system can perform with better accuracy and speed.

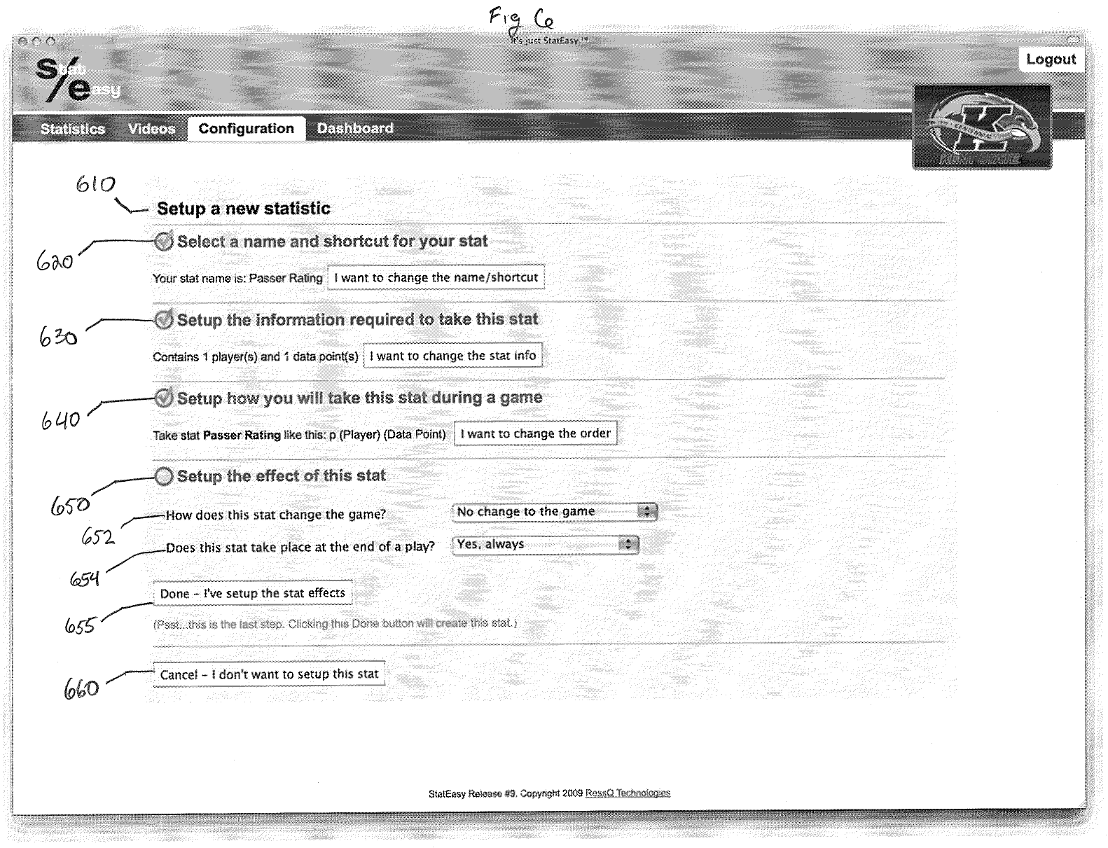

FIG. 6 is a diagrammatic illustration of a computer display screen shot for a specific exemplary embodiment of a configuration user interface of the present disclosure to set up the effect of a stat. FIG. 6 shows detail of the interface shown in FIG. 5 to illustrate what a user sees when they set up a stat. Steps that have been completed show a check mark and the contents of the completed step are hidden. For example, to set up a stat effect, activate link 560 in FIG. 5 to display set up page 610. Stat effect set up page 610 provides without limitation stat name and short cut set up 620, required information set up 630, set up how to take the stat during a game 640, set up the effect of the stat 650, which further provides without limitation sub-set up inputs how does the stat change the game 652 and does this stat take place at the end of a play 654, and the done virtual button 655 to complete setting up the stat effect. A cancel button 660 is also provided.

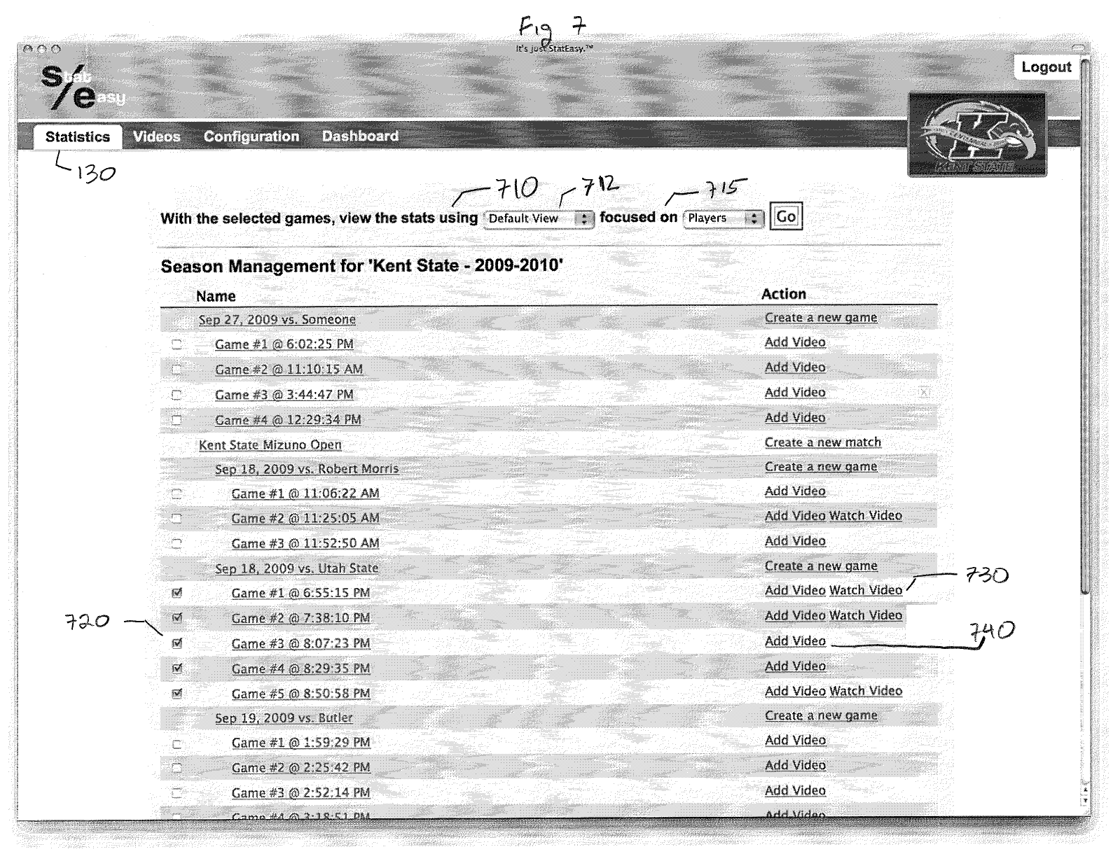

FIG. 7 is a diagrammatic illustration of a computer display screen shot for a specific exemplary embodiment of a report generation user interface of the present disclosure. In this screenshot, the user selects which games 720 he or she is interested in running a report for. The sentence 710 on the top asks the user to select which report they would like to see using a drop down menu as well as other configurable parameters for the report, such as without limitation the desired view 712, which can restrict the number of players for which a report is generated, for example, and focus on 715, which configures reports that focus on players, focus on games, focus on rotations and so forth. The action column on the right provides video features such as watch video 730 or add video 740.

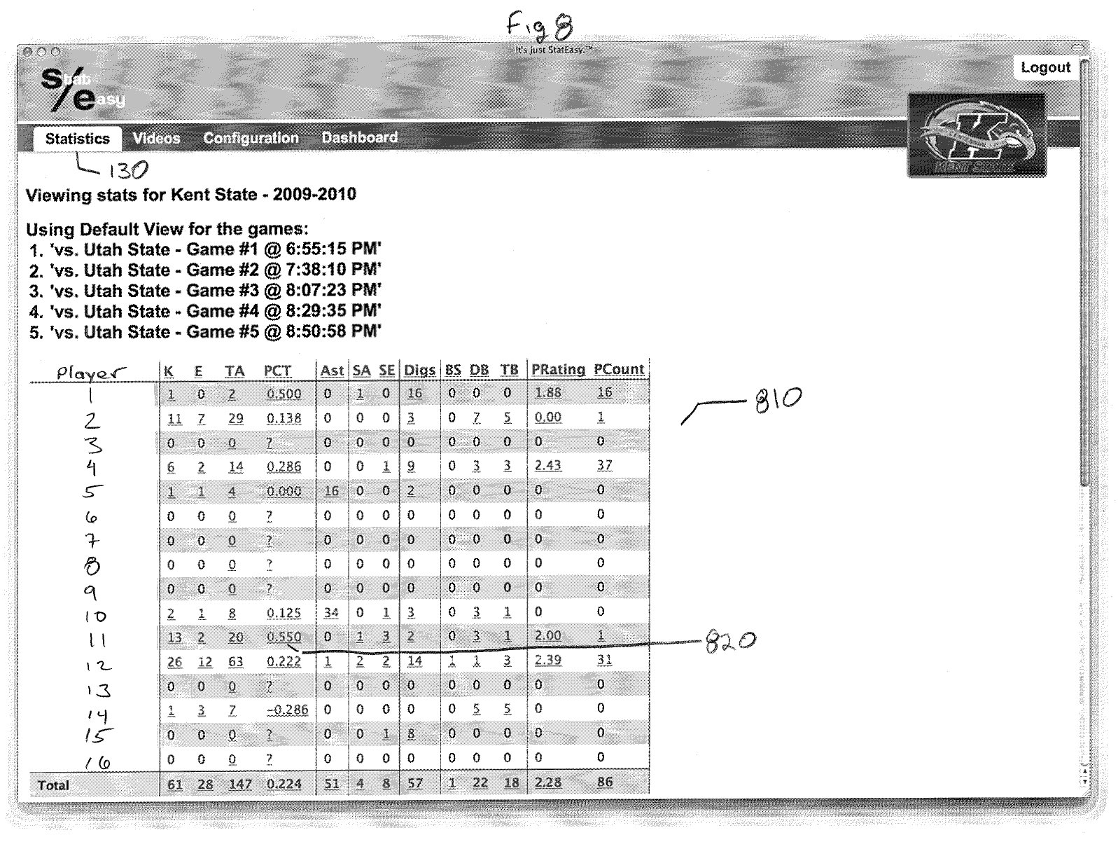

FIG. 8 is a diagrammatic illustration of a computer display screen shot for a specific exemplary embodiment of a report generated from the interface of FIG. 7. Report 810 includes without limitation certain numerical stats that are underlined or otherwise activatable. Any of the underlined information, such as PCT stat 0.550 for player 11, in report 810 is selectable results in a video being displayed to the user that contains only the statistics that were used to generate the bit of information that was clicked on. The video shows the collection of all events that generated the 0.550 stat that was activated in report 810.

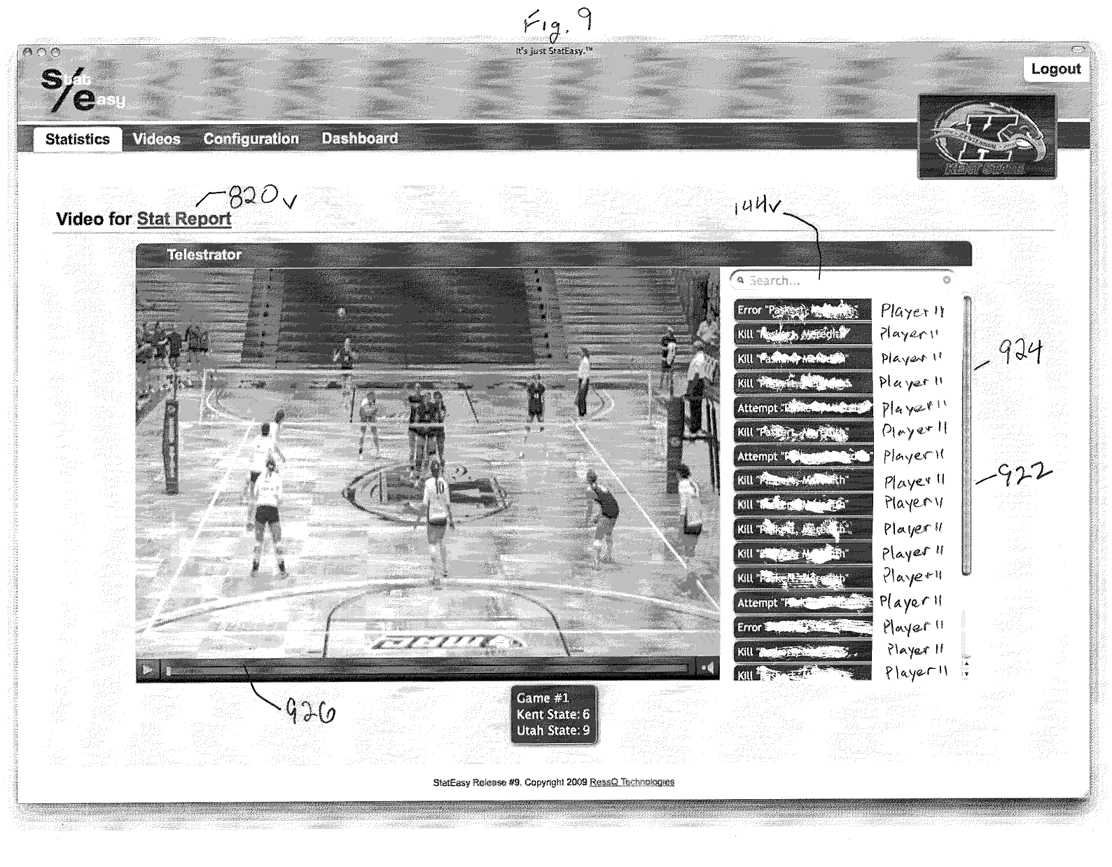

FIG. 9 is a diagrammatic illustration of a computer display screen shot for a specific exemplary embodiment of a video segment play interface of the present disclosure. Video for stat report 820v shows a video 926 where the user clicked on the 0.550 number for player 11 in FIG. 8. Notice that all stats 144v are for player 11. The stats that have no video associated, linked or synchronized to them 922 are distinguish by highlight color from those stats that do have a video 924.

FIG. 10 is a process flow diagram for synchronizing a stat to a video segment in accordance with the present disclosure. At its core, a synchronization point contains two vital pieces of data, which stat the synchronization point belongs to and when in the video the user would like to see that stat happen. From this information, the system can calculate a delta such that: originalStatTime+calculatedDelta=desiredTimeInVideo. This calculated delta is then applied to any subsequent statistic in the game until another synchronization point is associated to a statistic. A specific exemplary embodiment of the method steps provides:

Set the current sync point·=the first sync point 1010;

Starting with the first stat in the game and looping through every stat in the game, determine if there is a sync point associated with this stat 1020. If there is not then the current sync point is used 1030. If there is, set that sync point as the current sync point 1040; and

Using the current sync point and its associated delta value, take the current stat and add the delta 1050. Use this new value as the time the user would like the stat to happen in the video 1060. At the end of that loop, every stat in the game will have been adjusted appropriately to its new time.

StatEasy Server

Specific embodiments enable data from the Stateasy client run on a device connected via a network to the internet to be uploaded to an internet server such as the Stateasy Server. The StatEasy Server is the public component of the StatEasy client application. It is the public portal for any team or organization that uses the StatEasy Client and wishes to benefit from sharing player statistics & video with the world. Much of the StatEasy client is reused for the StatEasy server. The noticeable differences between the Client and Server applications are
The Server application has greater performance requirements.
The Server application adds “social network” type features.
Players/Coaches can mark stats & video clips as their favorite.
Players/Coaches can collect stats & video clips into highlight reels.
Users may comment on videos.
The Server application has authentication requirements.
The Server application has “Top Ten Lists” for different sports and statistics.
These lists can be broken down by state or region.
These lists are focused on a particular orderable statistic.
The Server application contemplates without limitation public vs. private statistics & videos.
The coach controls access to the statistics & videos.

Players as End Users

Players who log into StatEasy Server are able to verify their membership to a particular team and begin organizing and reviewing their statistics. The intent is to allow the player to use StatEasy to review tape from previous games as well as begin to collect video clips to be added to their personal highlight reel. These video clips can be made public and distributed to college recruiters, for example.

Coaches as End Users

Coaches who log into StatEasy Server are focused on reviewing game footage and analyzing what went well and not so well in each game. Coaches will be able to create additional views in StatEasy Server and publish them for players, fans and recruiters alike. Coaches will be able to upload data (statistics, videos, views, and so forth.) to StatEasy Server from StatEasy Client in an automatic or manual manner.

Recruiters as End Users

Recruiters who log into StatEasy Server will be able to watch all videos and video clips marked as public. They will also be able to see any statistics marked as public by any coach in the system.

One or more specific embodiment of StatEasy are implemented via software executed by a machine, wherein software is understood to be a set of instructions encoded onto some form of machine readable/executable media. A machine in the form of a computer system within which a set of instructions, when executed, may cause the machine to perform any one or more of the functions discussed herein and thereby transform the state of the computer system such as, for example, by changing the information displayed by a display screen of the computer system.

In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a gaming console, a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, the term “machine” shall also be taken to include any collection of machines that individually or jointly execute a set (or multiple sets) of instructions to perform any one or more of the methodologies discussed herein.

The computer system may include a processor (e.g., a central processing unit (CPU), a graphics processing unit (GPU), or both), a main memory and a static memory 606, which communicate with each other via a bus. The computer system may further include a video display unit (e.g., a liquid crystal display (LCD), a plasma display, a solid state display, or a cathode ray tube (CRT)). The computer system may include an input device (e.g., a true or virtual keyboard, microphone, camera and so forth), a cursor control device (e.g., a mouse, a mouse pad or a remote control), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated in herein above. The instructions may also reside, completely or at least partially, within the main memory, the static memory, and/or within the processor during execution thereof by the computer system. The main memory and the processor also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, specific exemplary embodiments of the system are applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, virtual machine processing, or phone “apps,” can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network 626 via the network interface device.

In addition to the foregoing embodiments, the present invention provides programs stored on machine readable medium to operate computers and devices according to the principles of the present invention. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, phone or tablet “apps” (applications for execution on a hand held device, for example) and many other existing and future forms which provide similar functionality as the foregoing examples, and any combinations thereof.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the description is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer system for keeping and analyzing one or more statistics of a sporting event, the system comprising:
a component for defining the statistics to be kept by the system;
a component for entering the defined statistics into the system;
a component for uploading entered statistics to an internet server;
a component for linking at least one video segment of an event that generates an entered statistic; and
a component for selectively displaying the video segment linked to the entered statistic.

2. The system of claim 1, wherein the component for entering defined statistics comprises voice recognition.

3. The system of claim 1, further comprising a component for uploading entered statistics and linked video to an internet server.

4. In a computer environment for keeping and analyzing sports statistics; a computer-readable medium having computer executable instructions for entering statistics in real time, uploading the entered statistics to an Internet server and linking a numerical statistic to at least one video clip of the event that generated the statistic, the computer executable instructions comprising:
providing a user interface to define the enterable statistics;
providing a user interface to enter the defined statistics as the events that generate the statistics occur;
recording video segments of the events that generate the entered statistics; and
linking to one or more entered statistics one or more video segments of the events that generated at least one of the entered statistics.

5. The computer readable medium of claim _, wherein the computer environment is a networked computer environment, the instructions further comprise uploading the entered statistics and linked video to an internet server.

6. A method for linking numerical statistics to a video of the event that generated the numerical statistic, the method comprising the steps of:
step 1—setting the current sync point=the first sync point;
step 2—determining if there is a sync point associated with the first stat;
step 3—if no sync point then the current sync point is used;
step 4—if there is a sync point, setting the sync point as the current sync point;
step 5—calculate delta from last sync point
step 5—reiterating steps 1-4 through every stat in the game; and
using the current sync point and its associated delta value, taking the current stat and add the delta to generate a new value;
setting the new value as the time for the stat to happen in the video such that at upon completion of the iterations, every synced stat is linked to a video of the appropriate event.
